(19) United States
(12) Patent Application Publication
(10) Pub. No.: US 2015/0361722 A1
(43) Pub. Date: Dec. 17, 2015

(54) Elevated free stand platform

(71) Applicant: Dennis Chick, Oklahoma City, OK (US)

(72) Inventor: Dennis Chick, Oklahoma City, OK (US)

(21) Appl. No.: 14/545,733

(22) Filed: Jun. 10, 2015

Related U.S. Application Data
(60) Provisional application No. 61/998,033, filed on Jun. 16, 2014.

(51) Int. Cl. E06C 7/16; E06C 7/50; E06C 7/42

(52) U.S. Cl. CPC E06C 7/16; E06C 7/42; E06C 7/50

(57) ABSTRACT

A portable free standing elevated observation platform incorporates a dual A-frame extension ladder with an upper elevated platform, the elevated platform serving as a framework for a wheeled axle and having a pivotal floor for below platform access, the dual A-frame extension ladder providing an extending rear frame support, a front frame support and a plurality of guy wires and anchors providing the platform with an elevated view of an area without the attachment or support of a tree.

### CROSS REFERENCE TO RELATED APPLICATIONS

Applicant claims the benefit of U.S. Provisional Patent Application No. 61/998,033, filed by the same inventor on Jun. 16, 2014.

### BACKGROUND OF INVENTION

1. Field of the Invention

A portable free standing elevated observation platform incorporates a dual A-frame extension ladder with an upper elevated platform, the elevated platform serving as a framework for a wheeled axle and having a pivotal floor for below platform access, the dual A-frame extension ladder providing an extending rear frame support, a front frame support and a plurality of guy wires and anchors providing the platform with an elevated view of an area without the attachment or support of a tree.

2. Description of Prior Art

A preliminary review of prior art patents was conducted by the applicant which reveal prior art patents in a similar field or having similar use. However, the prior art inventions do not disclose the same or similar elements as the present elevated platform device, nor do they present the material components in a manner contemplated or anticipated in the prior art.

Stands forming a platform have wheels that are either made part of the stand or connect to the stand. In U.S. Pat. Nos. 535,082 to Snell, 4,428,456 to Rohde, 5,195,611 to Untz, 6,186,271 to Borries and D359,133 to Dull, each of these disclosed prior art patent indicate a wheel attached to a ladder and having a platform. Dull is shown leaned against a tree without the need of being attached to the tree, while Snell, Untz, Rohde and Borries are all free standing with the need for a supporting structure. Snell and Untz disclose an A-frame type structure within the ladder. Rohde is a tripod tower. Borries, Untz, Rohde and Dull indicate a flat platform for sitting with some having a extended foot platform below the seat.

In U.S. Pat. Nos. 8,424,639 to Davis and 6,688,429 to McKay, a ladder and platform are integrated within a trailer, the trailer frame transforming into the ladder and platform, with McKay being a free standing device and Davis being erected next to a tree using the tree for support. A traveling stand attached to an ATV which has extendable ground-engaging legs is shown in U.S. Pat. No. 6,739,428 to Holmes.

A simple A-frame with a platform is shown in U.S. Pat. No. 444,280 to Pepin attaching a painter's platform. Two extended leg free-standing platforms are shown in U.S. Pat. No. 5,927,435 to Benton and 5,009,283 to Prejean, with the Benton patent being the only prior art patent discovered defining an elevated platform to include an entry to the platform deck through the floor with a hinged door in the floor of the platform to close subsequent to the user climbing above the floor and opened to permit access to the ladder when exiting the platform.

### SUMMARY OF THE INVENTION

There are location where an elevated platform is desired which does not have a tree with enough strength to support the platform, where potential damage to trees is prohibited, or in a location where there are no trees. The above prior art platforms identify several elevated platforms and tree stands that generally require the support or utilization of an available tree trunk for support.

The present elevated platform includes a ladder having a primary base ladder section extending a set of front legs and set of rear support legs forming a free standing base frame, and an extending upper ladder section including a fixed platform, the platform defining a platform frame, at least one hinged platform floor panel integrated within a floor frame to allow a user access through the floor frame from below the platform as the user climbs the upper ladder section, a safety rail, and a seat, and a detachable axis and set of wheels removably attached to a front edge of the platform floor frame providing the device to be transported along a ground surface and adapting the platform device for use as a hand-truck trailer for gear or game. The platform would also include additional safety elements including a plurality of attached guy lines and ground stakes, and may include a platform harness, a winch to raise and lower the extending ladder section from the stationary ladder section and other commonly used safety accessories generally used with high platform devices. It may be used without a supporting structure or with a supporting structure, the user having the option regardless of terrain and vegetation.

### DESCRIPTION OF THE DRAWINGS

The following drawings are submitted with this utility patent application.

FIG. 1 is a front perspective view of the erect and fully extended elevated free stand platform.

FIG. 2 is a side view of the elevated free stand platform in a collapsed position with the axle and wheels attached for ground transport.

FIG. 3 is a side view of the elevated free stand platform in an upright position prior to the extension of the upper ladder section from the lower ladder section.

FIG. 4 is a side view of the elevated free stand platform in an upright position subsequent to the extension of the upper ladder section from the lower ladder section.

FIG. 5 is a perspective isolated view of the platform attached to the upper ladder section showing the attachment and removal of the axle bracket extensions of the axle in relation to the axle brackets extending from the front margin of the platform base. FIG. 6 is a perspective isolated view of the platform attached to the upper ladder section showing the folded position of the safety rail, the seat and the floor plates.

### DESCRIPTION OF THE PREFERRED EMBODIMENT

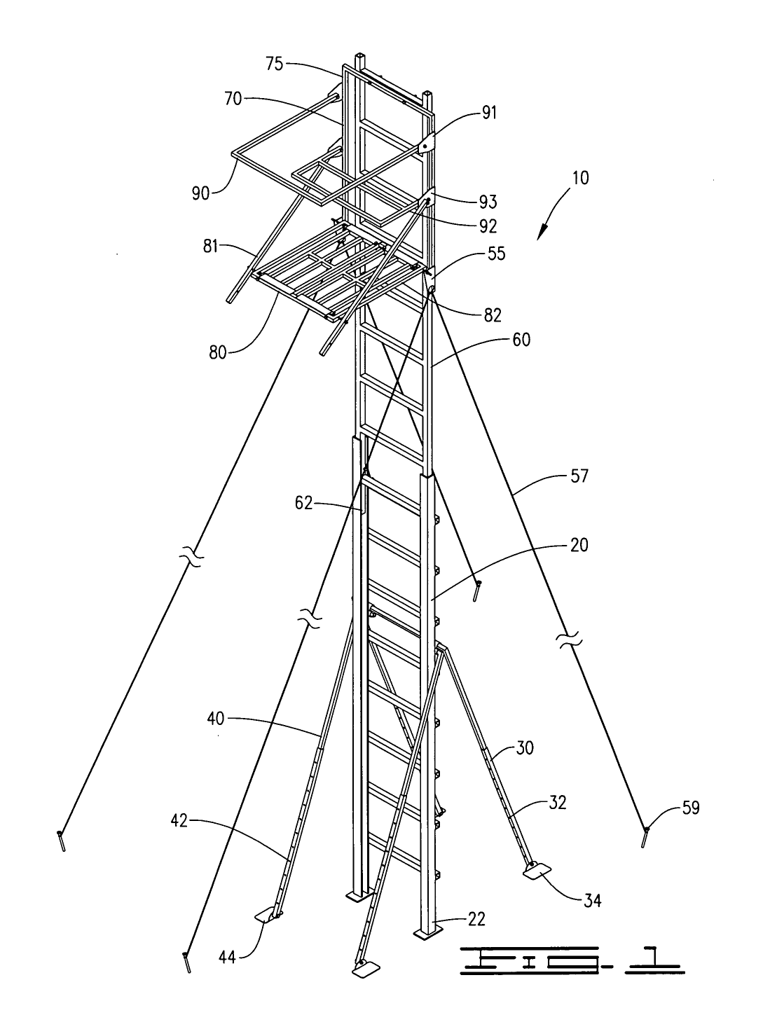

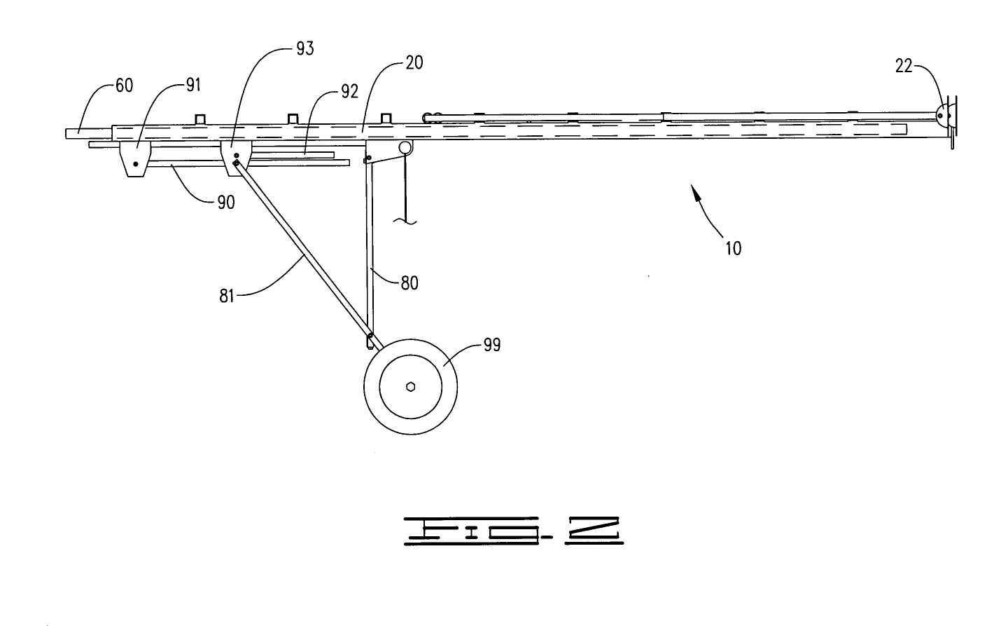

A free standing elevated platform assembly 10 providing placement of a secure elevated platform without attachment to a tree or other structure, shown in FIGS. 1-6 of the drawings, the platform assembly 10 comprises a base ladder section 20 slidable engaging an upper ladder section 60, the base ladder section 20 foldably extending a pair of telescoping rear support legs 30 with an independent locking means 32 to extend and secure each rear support leg 30, and a pair of front telescoping support legs 40 with an independent locking means 42 to extend and secure each front support leg 40, a locking means 50 to selectively secure the upper ladder section 60 to the base ladder section 20 together at a desired elevation, and a platform 70 attached to the upper ladder section 60 forming a platform base 80, a perimeter safety rail 90 and a seat 92. The base ladder section 20 and the upper ladder section 60 are provided with a plurality of guy wire extensions 55 to which guy wires 57, or “ropes” which within this application are singularly referenced as guy wires, are attached and anchored to the ground using an independent ground anchor 59. The platform base 80 extends a pair of parallel axle brackets 84 which connect to bracket extensions 97 extending from an axle 95 having a pair of wheels 99, each axle bracket 84 and bracket extension 97 connecting respectively by an axle locking means 98.

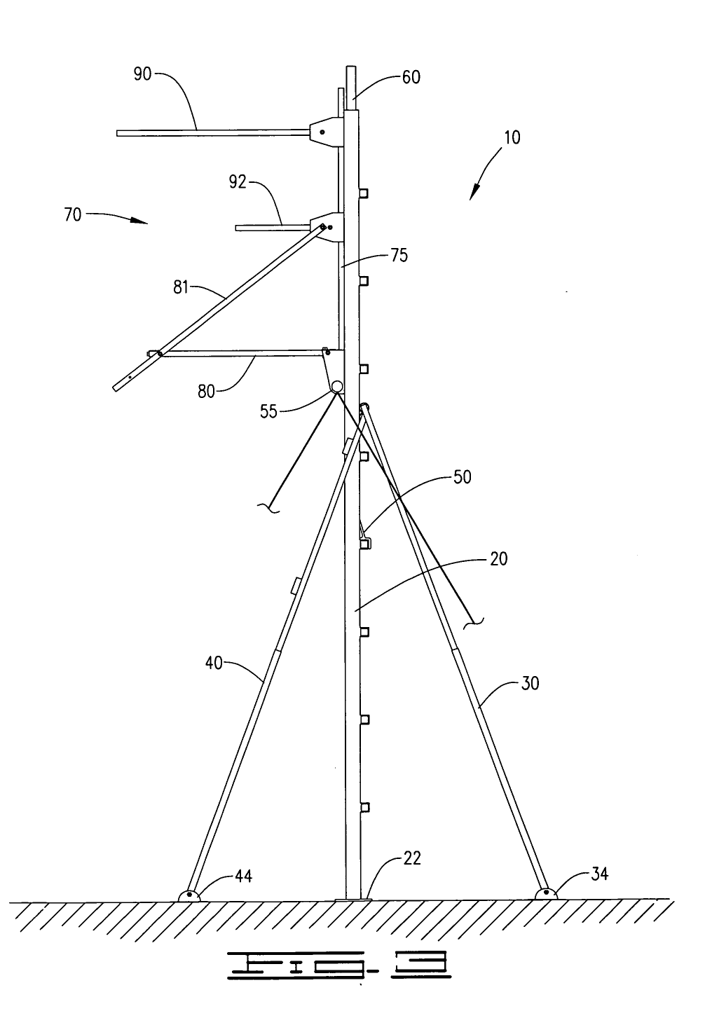

The assembly 10 is provided in a collapsed position, shown in FIG. 2, wherein the base ladder section 20 and upper ladder section 60 form a collapsed transport position, with a bottom 22 of the base ladder section 20 and the bottom 62 of the upper ladder section 60 nearest one another. In this position, each axle bracket 84 and bracket extension 97 are connected, providing the assembly 10 with a mobile capacity with the wheels 99 positioned towards the ground to roll the entire assembly 10 with the lower ladder section 20 and the platform 70 directed downward. In this collapsed transport position, the upper ladder section 60 may be used as a trailer to carry gear upon the assembly 10, the assembly pulled by hand or towed behind a ground transport vehicle.

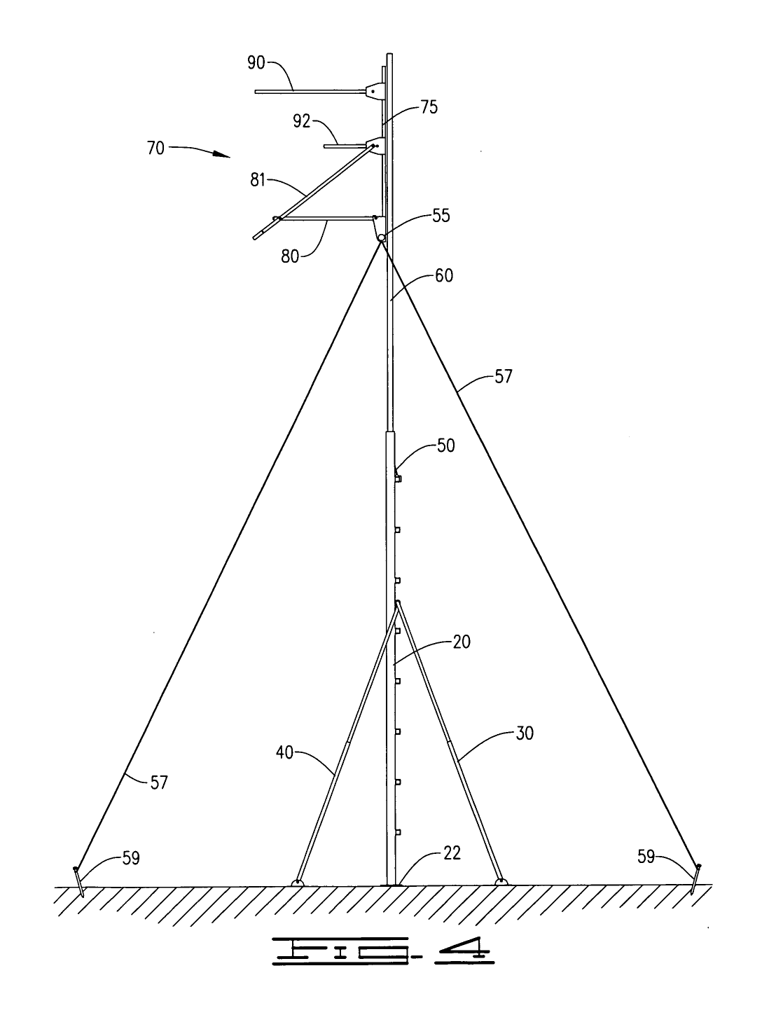

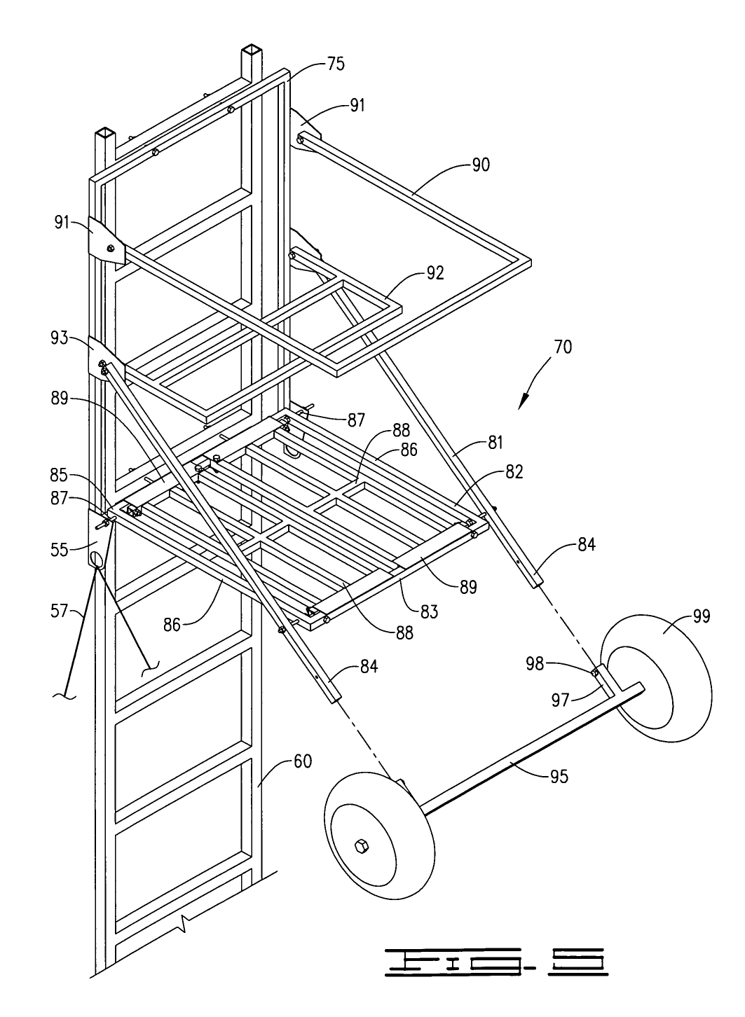

The assembly 10 is deployed into an erect position, FIGS. 1, 3 and 4, using the following steps of disconnecting the axle bracket 84 and bracket extension 97 to remove the axle 95 and wheels 99 from the platform 70, orienting the assembly 10 with the front margin 83 of the platform base 80 on the ground, extending the rear support legs 30 from the lower ladder section 20 and activating the locking brace assembly 22 for each rear support leg 20, elevating the base ladder section 20 and upper ladder section 60 into and upright position , resting upon the bottom 22 of the base ladder section 20 and each rear support leg 30, extending each front support leg 40 from the base ladder section 20 and activating the locking brace assembly 42 for each front support leg 40, FIG. 3, extending the upper ladder section 60 from the lower base section 20 to a selected height, FIG. 4, activating the ladder locking means 50 to secure the upper ladder section 60 to the lower ladder section 20 at the selected height, and applying the ground anchors 59 and guy wires 57 to secure the assembly 10 required to stabilize the erect assembly 10 in all directions.

The platform 70 further defines a platform mounting frame 75 attached to the upper ladder section 60 by welding or by other mounting means, the platform mounting frame 75 extending the platform base 80, the safety rail 90 and the seat 92. A supplemental base support bracket 81 may further attach the platform base 80 to the platform mounting frame 75, which would allow for the pivotal placement of the platform base 80 in one embodiment allowing the platform base 80 to be folded against the platform mounting frame 75, not shown, locking the platform base in a perpendicular relationship to the platform mounting frame 75. It is also preferred that the axle brackets 84 extend from this base support bracket 81, FIG. 2, for the attachment of the bracket extensions 97, axle 95 and wheels 99 to be attached in the collapsed position for transport. The platform base 80 further defines a lower base frame 82 formed by the front margin 83, a rear margin 85 attached to the platform mounting frame 75, and two side margins 86, containing at least two hinges 87 which are connected to a floor plate 88, the two floor plates 88 directed towards on another forming a stable standing surface. Each floor plate 88 is independently hinged upward, allowing a person climbing the elevated and secured upper and lower ladder sections to enter the platform 70 from below, subsequently closing the floor plates 88 after ascending above the lower base frame 82. The safety rail 90 is positioned above the platform base 80 and attached to the platform mounting frame 75 to provide a hand rail to a person within the platform 70 and to prevent a person from falling out of the platform 70 while standing on the platform base 80 and platform floor plates 88. The safety rail 90 may be affixed to a set position, or it may be supplied as a collapsible component, FIGS. 2 and 6, by incorporating a rail hinge 91 allowing the rail 90 to be folded against the platform mounting frame 75. The seat 92 is attached to the platform mounting frame 75 at a level above the platform base 80 and below the safety rail 90 to provide the user with seating on the seat 92 or the option to stand on the platform floor plates 88 as the user chooses. The seat 92 may be affixed to a set position or it, too, may be supplied as a collapsible component, FIGS. 2 and 6, by incorporating a seat hinge 93 allowing the seat 92 to be folded against the platform mounting frame 75.

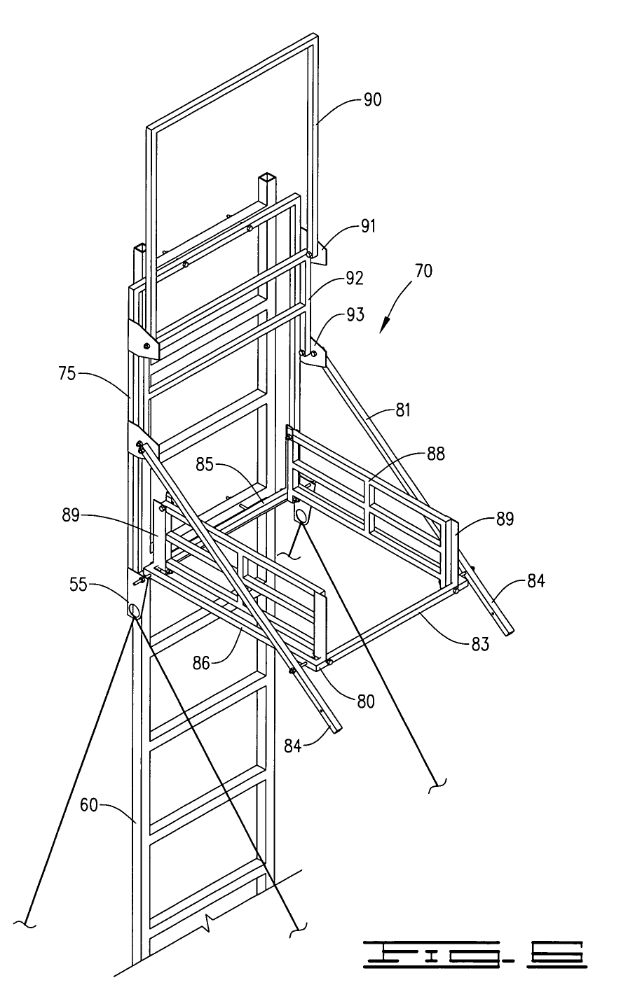

At least one or more floor plate extension 89 is provided on each floor plate to prevent the floor plate from hinging downward below the front margin 83 and rear margin 85, FIG. 5. It is contemplated that the floor plate extensions 88 may also include a latching means to retain the floor plates against the lower base frame 82 during transport and also subsequent to the user gaining entry onto the platform to keep the floor plates 88 in place and prevent them from becoming accidentally dislodged.

It is also contemplated that the assembly 10 could be used in conjunction with a tree or other support structure, including a pole, a building or other solid structural embodiment. It does not necessarily require a free-standing use, although it is most suited for such independent use. In this use, the assembly would be secured using a strap or band to secure the upper ladder section to the tree, pole or other structural embodiment.

Locations for the guy wire extensions 55 would be best presented upon the upper ladder section 60 and platform 70, with an abundant supply of guy wire extensions 55 for a sufficient number of guy wires 57 to be attached to ground anchors 59 for sufficient securing of the assembly 10 when extended and erected for use. The more guy wire extensions 55, guy wires 57 and ground anchors 59 used, the more secure would be the assembly 10 in the erect position. It is also recommended that more guy wires 57 be used where the user is heavier, more prone for movement or where there is higher wind which could topple the assembly 10. It is further recommended that the assembly 10 be used on flat and level terrain, although some grade below the assembly can be overcome with adjusting the tension of the guy wires 57 and positioning of the ground anchor 59 to which the guy wires 57 would be attached. In the event that the assembly would be placed on uneven terrain, it is contemplated that an independent leveling means 34, 44, would be included on each rear support leg 30 and front support leg 40.

Taking down the assembly 10 and returning it into the collapsed position would require the reverse steps as involved in the deployment of the assembly 10 into the erect position. Once collapsed, the assembly 10 may be used again to trailer the user and his equipment from the location where the assembly 10 has bee used, including the trailering of any game, camping gear, hunting gear or inclimate weather gear. In the collapsed position, the assembly 10 may be towed behind a transportation vehicle of carried in the back of a truck, although precautions should be taken in the event the assembly 10 would constitute an oversized load. It is also contemplated that the assembly 10 may include traffic signaling equipment, not shown, consistent with the traffic laws in the event the assembly is actually towed behind a highway vehicle, the signaling equipment integrated with the traffic lights or electrical plugs supplied on the transport vehicle, similar to a boat or trailer.

While the free standing elevated platform assembly 10 has been particularly shown and described with reference to a preferred embodiment thereof, it will be understood by those skilled in the art that changes in form and detail may be made therein without departing from the spirit and scope of the invention.

What is claimed is:

1. A free standing elevated platform assembly for the placement of a secure elevated platform on a ground surface without attachment to a tree or other structure comprising:
a base ladder section foldably extending a pair of rear support legs, each rear support leg engaging an independent locking means to extend and secure each said rear support leg from said base ladder section and a pair of front support legs, each front support leg engaging an independent locking means to extend and secure each said front support leg from said base ladder section;
an upper ladder section including a ladder locking means to selectively secure said upper ladder section to said base ladder section at a desired elevation;
a platform attached to said upper ladder section defining a platform mounting frame, a platform base, a perimeter safety rail and a seat, said platform base defining a pair of parallel axle brackets, said platform base further defining a lower base frame with said front margin, a rear margin attached to said platform mounting frame attaching to said upper ladder section and a supplemental base support bracket between said platform mounting frame and said front margin of said platform base, and two side margins, containing at least two hinges connected to an independent floor plate, said two floor plates directed towards on another forming a platform floor, each floor plate independently hinged upward, permitting a person climbing said upper and lower ladder sections to enter said platform from below, subsequently closing said floor plates after ascending above said platform floor supporting the user upon the platform;
bracket extensions extending from an axle having a pair of wheels, each said axle bracket and bracket extensions connecting respectively by at least one axle locking means; and
a plurality of guy wire extensions provided upon said upper ladder section and said platform to which guy wires are attached and anchored to the ground by an independent ground anchor.

2. The elevated platform assembly as disclosed in claim 1, said assembly further comprising:
a collapsed position wherein said base ladder section and upper ladder section are suited for ground transport, with a bottom of said base ladder section and a bottom of said upper ladder section even with one another, said axle bracket and said bracket extension connected, providing said assembly with a mobile capacity with said wheels positioned upon the ground to roll said assembly with said lower ladder section and said platform directed downward, said upper ladder section used as a trailer to carry gear upon said assembly, said assembly pulled by hand or towed behind a ground transport vehicle.

3. The elevated platform assembly as disclosed in claim 1, said platform further comprising:
said platform mounting frame attached to said upper ladder section by welding or by other mounting means, said platform mounting frame extending said platform base, said safety rail and said seat, said safety rail positioned above said platform base and attached to said platform frame to provide a hand rail to a person within the platform and to prevent a person from falling out of the platform while standing on the platform base and platform floor, said safety rail supplied as a collapsible component, and said seat attached to said platform frame above said platform base and below said safety rail allowing said user to either sit on said seat or to stand on said platform floor as the user chooses, said seat supplied as a collapsible component.

4. The elevated platform assembly as disclosed in claim 1, each said rear support leg and front support leg further comprising an independent leveling means for enhanced stability on uneven terrain.

5. The elevated platform assembly as disclosed in claim 1 further comprising:
a seat hinge attaching said seat to said platform mounting frame allowing said seat to be extended perpendicular for seating or folded against said platform mounting frame;
a rail hinge attaching said safety rail to said platform mounting frame allowing said safety rail to be extended or folded against said platform mounting frame.

6. The elevated platform assembly as disclosed in claim 1 further comprising any other feature as disclosed within the specification.
